(19) United States
(12) Patent Application Publication
(10) Pub. No.: US 2026/0356112 A1
(43) Pub. Date: Nov. 12, 2026

(54) SHEET CONVEYANCE APPARATUS, IMAGE FORMING SYSTEM, AND METHOD&#x0D; OF CONTROLLING SHEET CONVEYANCE APPARATUS

(71) Applicant: CANON KABUSHIKI KAISHA, Tokyo (JP)

(72) Inventor: SHIGEO HONGU, Ibaraki (JP)

(21) Appl. No.: 19/568,525

(22) Filed: Mar. 16, 2026

(30) Foreign Application Priority Data
Mar. 17, 2025 (JP) 2025-042447

(51) Int. Cl. B41J 13/32; B41J 3/46; B41J 13/00; B41J 13/30

(52) U.S. Cl. CPC B41J 13/32; B41J 3/46; B41J 13/0018; B41J 13/30

(57) ABSTRACT

A sheet conveyance apparatus includes first and second conveyance rollers, first and second driving units, first and second detection units, and a control unit. The control unit is configured to execute first processing so as to reduce a difference between a first conveyance speed of the sheet through the first conveyance roller and a second conveyance speed of the sheet through the second conveyance roller based on a first detection result in which a leading edge of a predetermined sheet is detected by the first detection unit, a second detection result in which a trailing edge of the predetermined sheet is detected by the first detection unit, a third detection result in which the leading edge of the predetermined sheet is detected by the second detection unit, and a fourth detection result in which the trailing edge of the predetermined sheet is detected by the second detection unit.

### BACKGROUND

### Field of the Technology

The present disclosure relates to a sheet conveyance apparatus that conveys a sheet, an image forming system, and a method of controlling the sheet conveyance apparatus.

### Description of the Related Art

There is known an image forming apparatus having a skew correction mechanism that corrects skew of a sheet being conveyed. As the skew correction mechanism, for example, there is one in which two separate conveyance rollers (drive rollers) are provided in a sheet width direction, and each conveyance roller is driven at an independent speed by a separate driving source to adjust the orientation of the sheet and correct the skew.

JP 2001-19212 A discloses a sheet conveyance apparatus in which a sheet bundle is nipped and conveyed by conveyance rollers from above and below. This sheet conveyance apparatus includes an upper conveyance roller, a lower conveyance roller, an upper motor that drives the upper conveyance roller, and a lower motor that drives the lower conveyance roller.

Here, in a case where different driving sources are used, there is a possibility that the rotational speeds of the conveyance rollers are not equal due to differences in characteristics between the driving sources. In addition, the two conveyance rollers do not necessarily deteriorate to the same extent, and one of the conveyance rollers may deteriorate more than the other conveyance roller, and as a result, rotational speeds of the two conveyance rollers may not be equal. Therefore, even if the outputs of the two driving sources are controlled to the same target speed, the sheet conveyance speeds of the two conveyance rollers are different, which may result in a decrease in accuracy of skew correction.

### SUMMARY

The present disclosure provides a sheet conveyance apparatus, an image forming system, and a method of controlling the sheet conveyance apparatus capable of improving accuracy of skew correction.

According to some embodiments of the present disclosure, a sheet conveyance apparatus includes a first conveyance roller configured to convey a sheet in a sheet conveyance direction, a first driving unit configured to drive the first conveyance roller, a second conveyance roller disposed at a position different from that of the first conveyance roller in a width direction intersecting the sheet conveyance direction, a second driving unit configured to drive the second conveyance roller, a first detection unit disposed on one side in the width direction, and configured to detect the sheet, a second detection unit disposed on another side opposite to the one side in the width direction, and configured to detect the sheet, and a control unit configured to control the first driving unit and the second driving unit. The control unit is configured to execute first processing to control at least one of the first driving unit and the second driving unit so as to reduce a difference between a first conveyance speed of the sheet through the first conveyance roller and a second conveyance speed of the sheet through the second conveyance roller based on a first detection result in which a leading edge of a predetermined sheet is detected by the first detection unit, a second detection result in which a trailing edge of the predetermined sheet is detected by the first detection unit, a third detection result in which the leading edge of the predetermined sheet is detected by the second detection unit, and a fourth detection result in which the trailing edge of the predetermined sheet is detected by the second detection unit.

According to another aspect of the present disclosure, a method of controlling a sheet conveyance apparatus including a first conveyance roller configured to convey a sheet in a sheet conveyance direction, a first driving unit configured to drive the first conveyance roller, a second conveyance roller disposed at a position different from that of the first conveyance roller in a width direction intersecting the sheet conveyance direction, a second driving unit configured to drive the second conveyance roller, a first detection unit disposed on one side in the width direction, and configured to detect the sheet, a second detection unit disposed on another side opposite to the one side in the width direction, and configured to detect the sheet, and a control unit configured to control the first driving unit and the second driving unit. The method includes a first step, executed by the control unit, of controlling at least one of the first driving unit and the second driving unit so as to reduce a difference between a first conveyance speed of the sheet through the first conveyance roller and a second conveyance speed of the sheet through the second conveyance roller based on a first detection result in which a leading edge of a predetermined sheet is detected by the first detection unit, a second detection result in which a trailing edge of the predetermined sheet is detected by the first detection unit, a third detection result in which the leading edge of the predetermined sheet is detected by the second detection unit, and a fourth detection result in which the trailing edge of the predetermined sheet is detected by the second detection unit.

Features of the present disclosure will become apparent from the following description of embodiments with reference to the attached drawings. The following description of embodiments is described by way of example.

### BRIEF DESCRIPTION OF THE DRAWINGS

FIG. 1A is a block diagram illustrating a schematic configuration of an image forming system according to the present embodiment.

FIG. 1B is a cross-sectional view illustrating a schematic configuration of an image forming system according to the present embodiment.

FIG. 2 is a block diagram illustrating a control system of the image forming system according to the present embodiment.

FIG. 3 is a block diagram illustrating a control system of a print server according to the present embodiment.

FIG. 4 is a cross-sectional view illustrating a first discharging apparatus according to the present embodiment.

FIG. 5 is a top view illustrating a positional relationship between a side regulating unit in a discharging stacker of the first discharging apparatus and a skewed sheet according to the present embodiment.

FIG. 6 is a top view illustrating positional relationships between a registration roller unit and a registration sensor unit in a skew correction unit of a first discharging apparatus and a sheet according to the present embodiment.

FIG. 7 is a top view illustrating a relationship in speed when a skewed sheet is conveyed to a registration roller unit in a skew correction unit according to the present embodiment.

FIG. 8 is a top view illustrating a relationship in speed when a skewed sheet is conveyed to a registration sensor unit in a skew correction unit according to the present embodiment.

FIG. 9 is a speed diagram illustrating a relationship between a time and a rotational speed of a driving motor in a skew correction unit according to the present embodiment.

FIG. 10 is a graph schematically illustrating a relationship between a rotational speed of a registration motor and an actual sheet conveyance speed in a case where a skew correction unit includes registration rollers having different radius according to the present embodiment.

FIG. 11 is a top view schematically illustrating a state in which a conveyed sheet remains skewed after skew correction due to a speed difference between registration rollers in a skew correction unit according to the present embodiment.

FIG. 12 is a timing chart illustrating a relationship between a sensor signal logic by which a registration sensor detects a first test sheet from its leading edge to its trailing edge and a target speed of a registration motor in a skew correction unit according to the present embodiment.

FIG. 13 is a timing chart illustrating a relationship between a sensor signal logic by which a registration sensor detects a second test sheet from its leading edge to its trailing edge and a target speed of a registration motor in a skew correction unit according to the present embodiment.

FIG. 14 is an explanatory view illustrating a display screen in a case where a speed adjustment operation of a skew correction unit is selected in a configuration in which first to third discharging apparatuses are connected according to the present embodiment.

FIG. 15 is a first half of a flowchart illustrating a procedure of processing for a speed adjustment operation of a skew correction unit in a configuration in which first to third discharging apparatuses are connected according to the present embodiment.

FIG. 16 is a second half of a flowchart illustrating a procedure of processing for a speed adjustment operation of a skew correction unit in a configuration in which first to third discharging apparatuses are connected according to the present embodiment.

FIG. 17 is a first half of a flowchart illustrating a procedure of processing for a speed adjustment operation of a skew correction unit according to the present embodiment.

FIG. 18 is a second half of a flowchart illustrating a procedure of processing for a speed adjustment operation of a skew correction unit according to the present embodiment.

FIG. 19 is a cross-sectional view illustrating a second discharging apparatus according to the present embodiment.

FIG. 20 is a top view illustrating positional relationships between a registration roller unit and a registration sensor unit in a skew correction unit of a second discharging apparatus and a sheet according to the present embodiment.

### DESCRIPTION OF THE EMBODIMENTS

Hereinafter, various exemplary embodiments, features, and aspects for carrying out the present disclosure will be described with reference to the drawings. In the present embodiment, a case where an inkjet recording system is applied as an image forming system 1 will be described.

### Inkjet Recording System

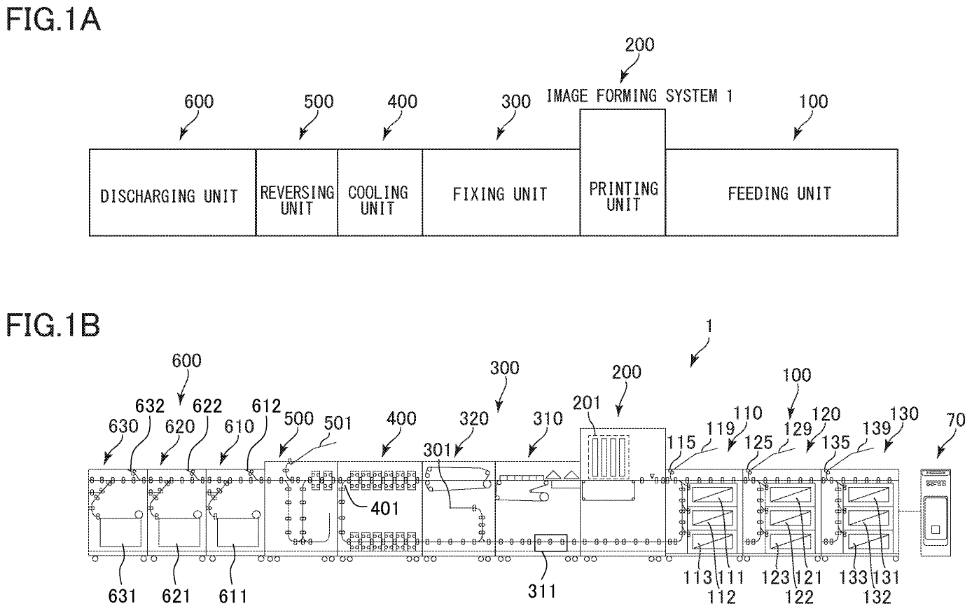

First, a schematic configuration of the image forming system 1 according to the present embodiment will be described with reference to FIGS. 1A and 1B. FIG. 1A is a block diagram illustrating a schematic configuration of an image forming system according to an embodiment. FIG. 1B is a schematic cross-sectional view illustrating a schematic configuration of an image forming system according to an embodiment. The image forming system 1 is a sheet-fed inkjet recording system that produces a recorded material by forming an ink image on a sheet (hereinafter, also referred to as “paper”) using two liquids: a reaction liquid and an ink. In the present embodiment, the paper refers to sheet-shaped plain paper, thin paper, thick paper, coated paper, or the like, but is not limited thereto, and may also be another type of paper or a sheet made of a material other than paper. In the present embodiment, feeding a sheet is referred to as feeding, and discharging a sheet is referred to as discharging, but the material of the sheet is not necessarily limited to paper.

As illustrated in FIG. 1A, the image forming system 1 includes six units: a feeding unit 100, a printing unit 200 serving as an image forming apparatus, a fixing unit 300, a cooling unit 400, a reversing unit 500, and a discharging unit 600.

As illustrated in FIG. 1B, in the present embodiment, the feeding unit 100 that feeds paper is configured by connecting (coupling) feeding apparatuses 110, 120, and 130 as three sheet conveyance apparatuses. The feeding apparatus 110 is a unit including feeding trays, and includes a first feeding tray 111, a second feeding tray 112, and a third feeding tray 113 serving as three-stage support parts that hold various types of printing paper used in a printing process. Furthermore, the feeding apparatus 110 further includes a discharging port 115 that can be used as a retraction destination for invalid paper, such as paper that cannot be normally conveyed to the printing unit 200 when a jam occurs, or paper that has been double-fed during feeding. Similarly, the feeding apparatus 120 includes a first feeding tray 121, a second feeding tray 122, and a third feeding tray 123 provided in three stages, and a discharging port 125. Similarly, the feeding apparatus 130 includes a first feeding tray 131, a second feeding tray 132, and a third feeding tray 133 provided in three stages, and a discharging port 135.

The printing unit 200 is a unit that prints a print image on printing paper, and includes an inkjet head 201 serving as an image forming unit. The inkjet head 201 constitutes an image forming unit that forms an image on paper that is being conveyed by performing a recording process (printing) in which an ink adheres onto the paper from above using a plurality of recording heads.

The fixing unit 300 is a unit responsible for controlling fixation to fix the image printed by the printing unit 200 onto the paper, and includes a drying module 310 and a fixing module 320. The drying module 310 blows hot air onto the paper to reduce the liquid content of the ink attached to the paper and improve the fixability between the paper and the ink. The fixing module 320 heats the paper using a plurality of heater units to fix the printed image to the paper. Note that the fixing unit 300 includes a discharging port 301 that can be used as a retraction destination for invalid paper.

The cooling unit 400 is a unit responsible for controlling the temperature to cool the paper heated by the fixing unit 300 and return the paper to normal temperature, and cools the paper using a plurality of fan units.

The reversing unit 500 is a unit responsible for controlling reversion of paper by switching back the conveyed paper to switch whether the printed side faces up or down when the paper is stacked on the subsequent discharging unit 600. Note that the reversing unit 500 includes a discharging port 501 that can be used as a retraction destination for paper that has become invalid.

The discharging unit 600 is a unit that controls discharging by conveying the sheet on which the image has been formed by the printing unit 200 and stacking the printed paper, and is configured by connecting (coupling) three discharging apparatuses: a first discharging apparatus 610, a second discharging apparatus 620, and a third discharging apparatus 630. The first discharging apparatus 610 is an example of a sheet conveyance apparatus or a first sheet conveyance apparatus. The first discharging apparatus 610 includes a discharging stacker 611 that supports and stacks the printed paper. In addition, the first discharging apparatus 610 includes a discharging port 612 that can be used as a retraction destination for the printed paper or invalid paper. The second discharging apparatus 620 is an example of a second sheet conveyance apparatus, and is connected downstream of the first discharging apparatus 610 in a sheet conveyance direction Df. The second discharging apparatus 620 includes a discharging stacker 621 and a discharging port 622, and the third discharging apparatus 630 includes a discharging stacker 631 and a discharging port 632. In the present embodiment, the case where the discharging unit 600 is configured by connecting three discharging apparatuses: the first discharging apparatus 610, the second discharging apparatus 620, and the third discharging apparatus 630 has been described, but the discharging unit 600 is not limited thereto, and may be configured by only one discharging apparatus 610. The discharging unit 600 will be described below.

A print server 70 is connected to the image forming system 1, and a print job is transmitted from the print server 70. The print server 70 can check the status of the image forming system 1, monitor the print job, and perform maintenance control such as a speed difference adjustment operation of a skew correction unit, and can comprehensively operate the various functions of the image forming system 1. The skew correction operation will be described in detail below.

### Control System of Image Forming System

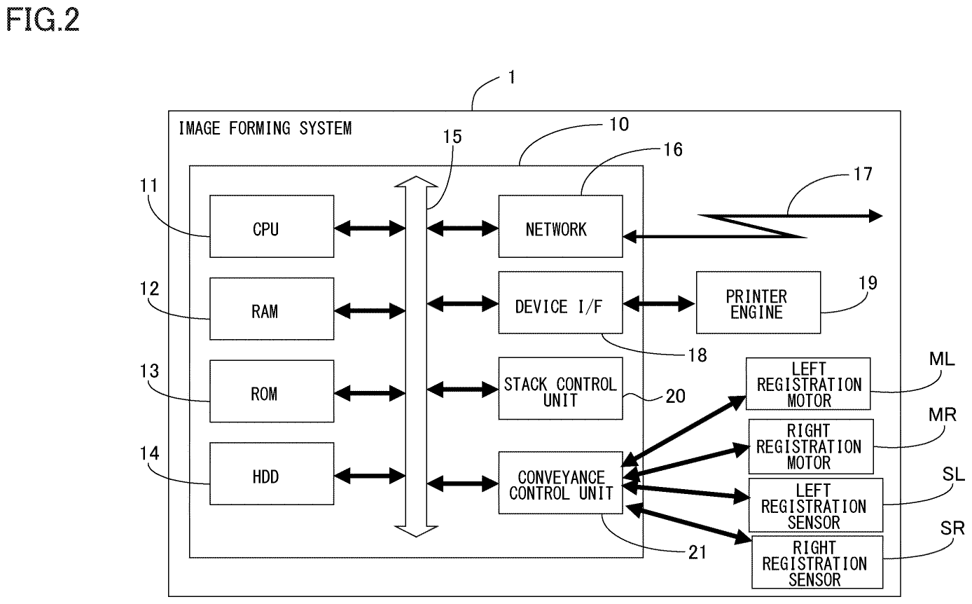

Next, a control system of the image forming system 1 will be described with reference to FIG. 2. FIG. 2 is a block diagram illustrating the control system of the image forming system 1 according to the present embodiment.

As illustrated in FIG. 2, the image forming system 1 includes a control unit 10. The control unit 10 is a controller unit that controls input and output of sensor signals and device information and execution of various control processes. For example, a program in which processing contents are described is stored in a read only memory (ROM) 13 or a hard disk drive (HDD) 14 and installed in the image forming system 1. A central processing unit (CPU) 11 of the control unit 10 reads the program stored in the ROM 13 or the HDD 14 into a random access memory (RAM) 12 and executes the program. Further, the CPU 11 comprehensively controls each device connected to a system bus 15. The RAM 12 functions as a main memory and a work memory of the CPU 11. The ROM 13 stores a boot program executed when the power is turned on, and the HDD 14 stores an operating system and a control program body of the present apparatus. The HDD 14 is also used for the purpose of temporarily or long-term holding large-capacity data.

A network 16 is connected to a local area network 17, and is responsible for inputting and outputting data and device information to and from the outside. Alternatively, the program can be installed in the ROM 13 or the HDD 14 via the network 16. A device interface (I/F) 18 is an interface unit with a printer engine 19, and inputs and outputs signals for operating and referring to various motors, sensors, inkjet heads, and the like connected to the printer engine 19. The printer engine 19 is an inkjet-type output device that conveys printing paper under the control of the control unit 10 and controls the inkjet head 201 (see FIG. 1B) to output an image transferred from the print server 70 onto the printing paper.

A stack control unit 20 is responsible for alignment control, home position operation control, and the like for stacking sheets using sensors and motors in the first discharging apparatus 610, the second discharging apparatus 620, and the third discharging apparatus 630. A conveyance control unit 21 is responsible for controlling conveyance motors and sensors for feeding printing paper from the feeding unit 100, conveying the paper in synchronization with the timing at which the ink is ejected from the inkjet head 201, and discharging the paper to the discharging unit 600. When it is detected that the state of the sensor has been changed, the detection time is stored in the RAM 12 for use in the control process. In addition, skew correction control is performed in such a manner that a left registration sensor SL and a right registration sensor SR detect that a sheet being conveyed is skewed, and a left registration motor ML and a right registration motor MR temporarily change speeds of registration rollers to correct the skew of the sheet.

Note that, here, the case where the control unit 10 (controller unit) is configured by one unit has been described. However, it is also possible to adopt a configuration in which a plurality of controller units are provided, one being separately provided for each of the feeding unit 100, the printing unit 200, the fixing unit 300, the cooling unit 400, the reversing unit 500, and the discharging unit 600. In this case, the specific controller unit comprehensively controls the other ones of the plurality of controller units.

### Control System of Print Server

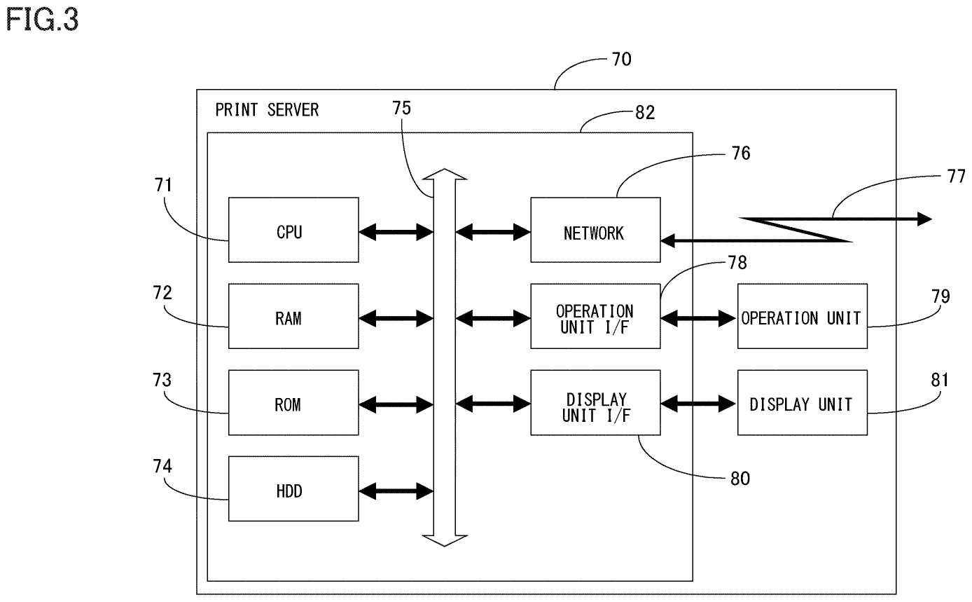

Next, a control system of the print server 70 will be described with reference to FIG. 3. FIG. 3 is a block diagram illustrating the control system of the print server 70 according to the present embodiment.

As illustrated in FIG. 3, the print server 70 includes a control unit 82. The control unit 82 is a controller unit that controls input and output of device information and execution of various control processes. A CPU 71 of the control unit 82 reads a program stored in a ROM 73 or an HDD 74 into a RAM 72 and executes the program. The CPU 71 comprehensively controls each device connected to a system bus 75. The RAM 72 functions as a main memory and a work memory of the CPU 71. The ROM 73 stores a boot program executed when the power is turned on, and the HDD 74 stores an operating system and a control program body of the present apparatus. The HDD 74 is also used for the purpose of temporarily or long-term holding large-capacity data.

A network 76 is connected to a local area network 77, and is responsible for inputting and outputting data and device information to and from the outside. Alternatively, the program can be installed in the ROM 73 or the HDD 74 via the network 76. An operation unit I/F 78 is connected to an operation unit 79, and the operation unit 79 receives various setting inputs and operation instructions from the user. A display unit I/F 80 is connected to a display unit 81, and the display unit 81 is an output device that displays information about the executed program as a still image or a moving image.

### Outline of Skew Correction Unit

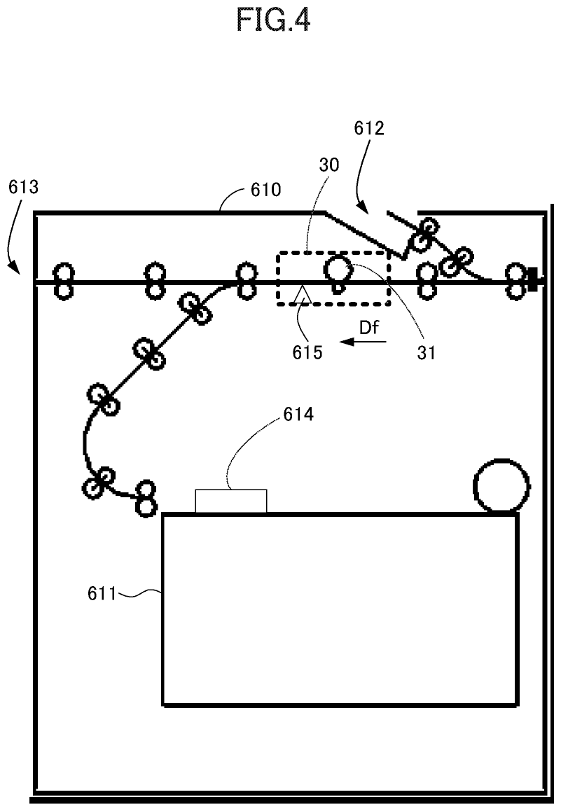

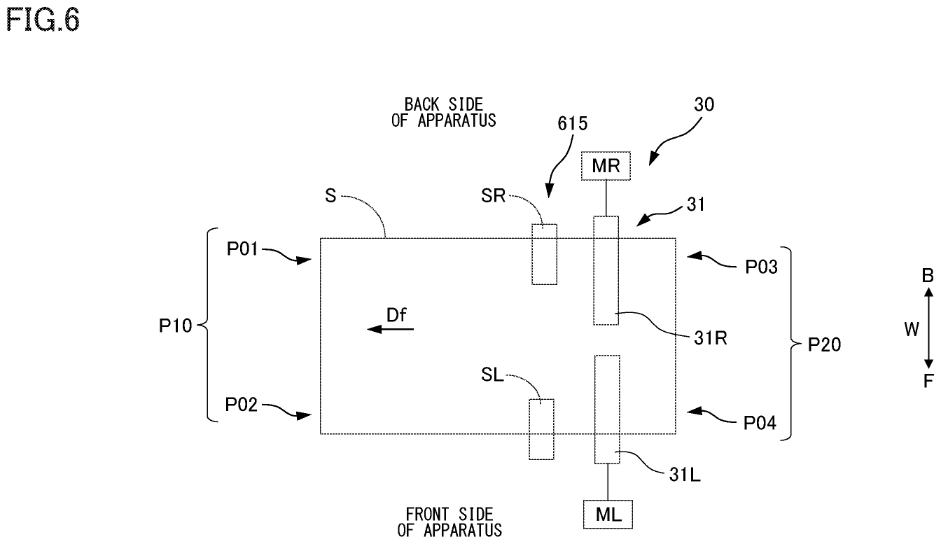

Next, a skew correction unit 30 will be described with reference to FIGS. 4 to 9. FIG. 4 is a schematic view of the first discharging apparatus 610 according to the present embodiment. FIG. 6 is a top view illustrating the skew correction unit 30. Here, the first discharging apparatus 610 will be described as a representative example, but the other discharging apparatuses, second discharging apparatus 620 and third discharging apparatus 630, have the same configuration.

As illustrated in FIGS. 4 and 6, the first discharging apparatus 610 includes a skew correction unit 30. The skew correction unit 30 includes a registration roller unit 31. The registration roller unit 31 includes two rollers arranged side by side in a width direction W intersecting (here, orthogonal to) the sheet conveyance direction Df. The roller disposed on a front side F, which is the front side of the apparatus, is referred to as a left registration roller 31L, and the roller disposed on a back side B, which is the back side of the apparatus, is referred to as a right registration roller 31R. In the present embodiment, the left registration roller 31L and the right registration roller 31R are arranged coaxially. That is, the right registration roller 31R is disposed at a position overlapping the left registration roller 31L when viewed in the width direction W.

The right registration roller 31R is an example of a first conveyance roller or a first conveyance unit, and conveys a sheet S in the sheet conveyance direction Df. The left registration roller 31L is an example of a second conveyance roller or a second conveyance unit, is disposed at a position different from that of the right registration roller 31R in the width direction W, and conveys the sheet S together with the right registration roller 31R. In the present embodiment, the skew correction unit 30 performs skew correction using only the registration roller unit 31, but the skew correction is not limited thereto, and may be performed using other turning rollers and the like in addition to the registration roller unit 31. In this case, the skew correction unit 30 may include a first conveyance unit including the right registration roller 31R and other rollers, and a second conveyance unit including the left registration roller 31L and other rollers.

The right registration motor MR is an example of a first driving unit, and drives the right registration roller 31R. The left registration motor ML is an example of a second driving unit, and drives the left registration roller 31L. Here, in the present embodiment, the two registration rollers are driven by the two separate driving sources. However, the driving of the two registration rollers is not limited thereto, and for example, even with one driving source, the two registration rollers may be driven by branching power from the driving source using two transmissions (driving units).

The sheet S includes a first detection target portion P10 and a second detection target portion P20 located at a position different from the first detection target portion P10 in the sheet conveyance direction Df. The first detection target portion P10 has a first detection target position P01 and a second detection target position P02 different in the width direction W. The second detection target portion P20 includes a third detection target position P03 overlapping the first detection target position P01 when viewed in the sheet conveyance direction Df, and a fourth detection target position P04 overlapping the second detection target position P02 when viewed in the sheet conveyance direction Df. In the present embodiment, the first detection target portion P10 is a leading edge of the sheet S in the sheet conveyance direction Df, and the second detection target portion P20 is a trailing edge of the sheet S in the sheet conveyance direction Df.

The skew correction unit 30 includes a registration sensor unit 615. The registration sensor unit 615 is an example of a first detection unit, and detects the first detection target portion P10 of the sheet S and the second detection target portion P20 of the sheet S. That is, the registration sensor unit 615 detects positions: the first detection target position P01, the second detection target position P02, the third detection target position P03, and the fourth detection target position P04. The registration sensor unit 615 includes a left registration sensor SL disposed on the front side F and a right registration sensor SR disposed on the back side B. The right registration sensor SR is an example of a first detection unit, and detects the first detection target position P01 and the third detection target position P03. The left registration sensor SL is an example of a second detection unit, and detects the second detection target position P02 and the fourth detection target position P04. The right registration sensor SR is disposed at a position overlapping the left registration sensor SL when viewed in the width direction W.

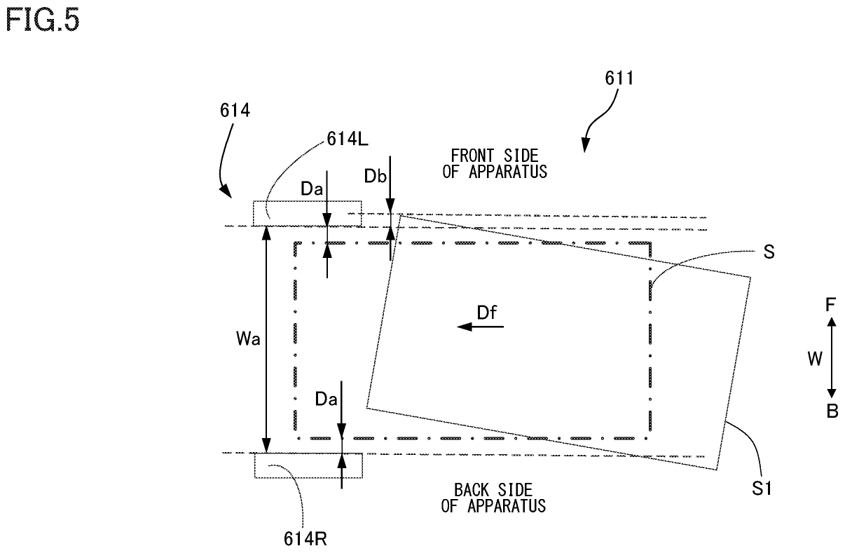

The sheet S conveyed in the first discharging apparatus 610 is discharged to the discharging port 612 or the discharging stacker 611. When the sheet is conveyed from the first discharging apparatus 610 to the second discharging apparatus 620, the sheet is conveyed to a connection conveyance port 613. The discharging stacker 611 is an example of a stacking portion, is disposed downstream of the registration roller unit 31 in the sheet conveyance direction Df, and stacks the sheet conveyed by the registration roller unit 31. The discharging stacker 611 includes a side regulating unit 614. The side regulating unit 614 includes a left side regulating plate 614L and a right side regulating plate 614R (see FIG. 5). The side regulating unit 614 is an example of a pair of side regulating portions, and abuts on ends in the width direction W of the sheet stacked on the discharging stacker 611 to regulate the position of the sheet.

### Discharging Stacker

FIG. 5 is a top view schematically illustrating a positional relationship between the side regulating unit 614 of the discharging stacker 611 and the skewed sheet S1. Here, in order to align the sheet conveyance direction Df when viewed with that in FIGS. 6 to 8, the front side and the back side of the image forming system 1 in FIG. 5 are reversed respect to those in FIG. 4.

The sheet S and the sheet S1 are conveyed to pass through the skew correction unit 30, subjected to skew correction, and then reach the side regulating unit 614 of the discharging stacker 611. The left side regulating plate 614L and the right side regulating plate 614R are side regulating members that are pressed against the side edges of the sheets by motors (not illustrated) to align the sheets. The sheet S indicates an ideal sheet conveyance position with respect to the left side regulating plate 614L and the right side regulating plate 614R. The sheet S is awaited in a state where the sheet S is spaced apart from the left side regulating plate 614L and the right side regulating plate 614R by a lateral alignment driving distance Da. Therefore, when the sheet S is conveyed to the discharging stacker 611, if the sheet S is not conveyed so as to fall within a spacing Wa between the left side regulating plate 614L and the right side regulating plate 614R, there is a possibility that the sheet S abuts against the left side regulating plate 614L and the right side regulating plate 614R, thereby causing damage to the sheet S.

The sheet S1 indicates a skewed sheet. The sheet S1 is skewed to such an extent as to have a conveyance skew deviation distance Db that does not fall within the spacing Wa of the side regulating unit 614, and abuts against the side regulating unit 614. Therefore, the present embodiment is to prevent the skew of the sheet S conveyed to the discharging stacker 611 from generating a conveyance skew deviation distance Db that does not fall within the spacing Wa and colliding with the side regulating unit 614 as is the case with the sheet S1 illustrated in FIG. 5.

### Details of Skew Correction Unit

FIGS. 6 to 8 are top views for explaining the operation of the skew correction unit 30 of the discharging stacker. A configuration of the skew correction unit 30 will be described with reference to FIG. 6. The left registration roller 31L and the right registration roller 31R are coaxially arranged side by side in the width direction. The left registration roller 31L is driven by the left registration motor ML, and the right registration roller 31R is driven by the right registration motor MR. In addition, the left registration sensor SL and the right registration sensor SR for detecting a degree of skew of the sheet S being conveyed are arranged side by side in the width direction W. The sheet S is an example of a sheet after skew correction in terms of posture and position. The left registration sensor SL and the right registration sensor SR are made of, for example, CISs, which can detect the leading edge and the trailing edge of the sheet being conveyed, respectively, and detection times are stored in the RAM 12 by the CPU 11. The CPU 11 determines skew based on the time between the stored detection times of the left registration sensor SL and the right registration sensor SR.

### Skew Correction Control

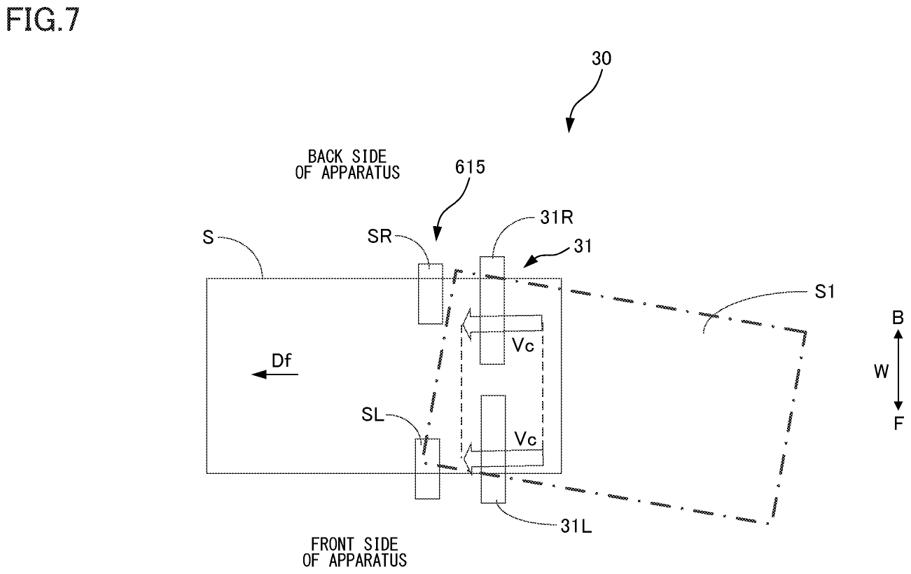

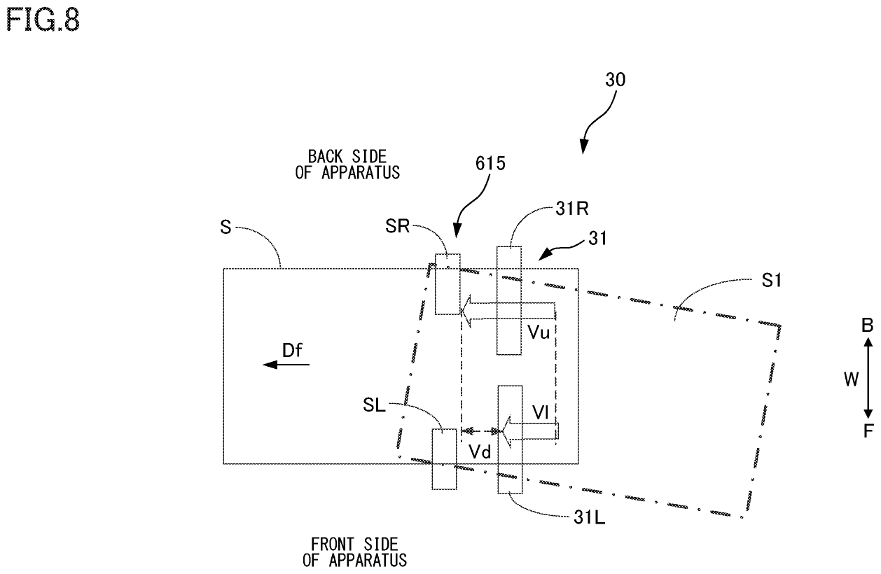

Next, skew correction control will be described with reference to FIGS. 7 and 8. FIG. 7 illustrates a state in which the sheet S1 before being subjected to skew correction is detected earlier by the left registration sensor SL but does not reach the right registration sensor SR due to skew, relative to the sheet S after being subjected to skew correction. At this time, it is assumed that both the left registration roller 31L and the right registration roller 31R are controlled for conveyance at a target speed of 1000 mm/s as a straight conveyance speed Vc.

Thereafter, as illustrated in FIG. 8, the right registration sensor SR also detects the sheet S, and an inclination of the sheet S is calculated based on a difference between times when the left registration sensor SL and the right registration sensor SR detect the sheet S. The difference in detection time between the detection time TL of the left registration sensor SL and the detection time TR of the right registration sensor SR multiplied by the target straight conveyance speed Vc is a distance difference Dskew between conveyance positions on the left registration sensor SL side and the right registration sensor SR side, which causes skew of the sheet. Therefore, a speed Vl and a speed Vu to be described below are determined so as to compensate for this distance difference Dskew.

Here, the left registration roller 31L located on the preceding side where the leading edge of the sheet has been detected earlier by the left registration sensor SL conveys the sheet S at the temporarily decelerated speed Vl, and the right registration motor MR located on the delayed side conveys the sheet S at the temporarily accelerated speed Vu. This gives a difference Vd in conveyance speed. The temporary acceleration and deceleration are performed during a period, for example, until the leading edge of the sheet is gripped by the rollers downstream of the left registration roller 31L and the right registration roller 31R in the conveyance direction and the movement of the sheet is restricted. In this manner, by decelerating the preceding side of the conveyance of the sheet S and accelerating the delayed side of the conveyance of the sheet S, the difference between positions of both sides is reduced, so that the skew of the sheet S1 can be corrected to the position of the sheet S.

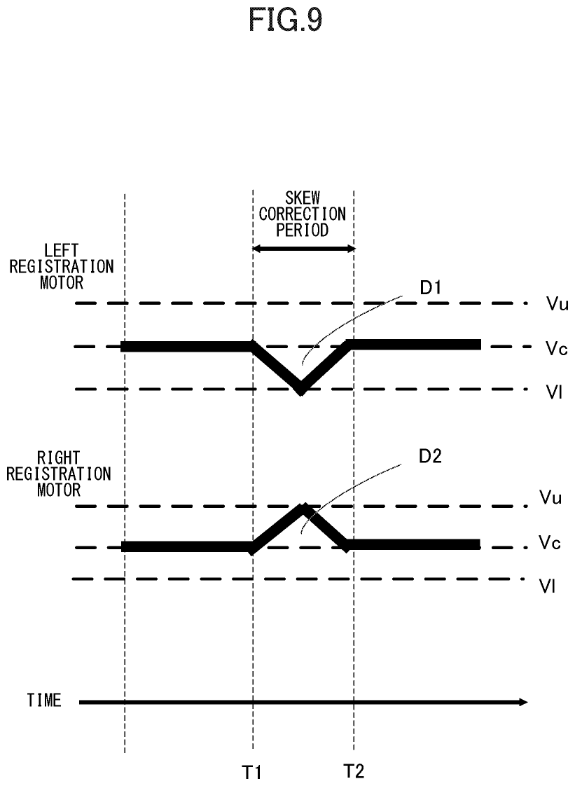

Next, a method of calculating the inclination of the sheet S and a method of determining the speed Vl and the speed Vu will be described with reference to FIG. 9. FIG. 9 is a speed diagram illustrating a relationship between a time and a motor rotational speed in the skew correction unit 30 of the first discharging apparatus 610. Hereinafter, a method of calculating the inclination of the sheet S and a method of determining the speed Vl and the speed Vu will be described as skew correction control. Here, the left registration motor ML and the right registration motor MR are stepping motors. A vertical axis illustrated in FIG. 9 represents a conveyance speed command value given to the registration motor, where the speed Vl is a speed Vl temporarily decelerated for correcting skew, and the speed Vu is a speed Vu temporarily accelerated for correcting skew. The straight conveyance speed Vc is a steady straight conveyance speed Vc used to move the sheet S straight before and after the skew correction control.

FIG. 9 illustrates target speeds of the left registration motor ML and the right registration motor MR in the skew correction control in the above-described case where the left registration sensor SL detects the sheet S earlier. The horizontal axis illustrated in FIG. 9 represents a time, where T1 is a timing at which the temporary acceleration and the temporary deceleration in FIG. 8 are started to start the skew correction, and T2 is a timing at which the temporary acceleration and the temporary deceleration in FIG. 8 are ended to end the skew correction. When the sheet S is skewed in the opposite direction and the right registration sensor SR detects the sheet S earlier, the left registration motor ML and the right registration motor MR have the reversed speed relationship.

In the example illustrated in FIG. 9, with the straight conveyance speed denoted by Vc, only during the skew correction period, the left registration motor ML located on the side where the sheet S precedes is driven at the temporarily decelerated speed Vl, and the right registration motor MR located on the side where the conveyance is delayed is driven at the temporarily accelerated speed Vu. Here, in order to calculate the inclination amount of the sheet S as described above, the difference between the detection time TL of the left registration sensor SL and the detection time TR of the right registration sensor SR is obtained. Here, it is assumed that TL−TR=5 msec (millisecond). At this time, by multiplying the straight conveyance speed Vc=1000 mm/s (millimeter per second), 1000 mm/s×5 msec=5 mm is calculated as the distance difference Dskew, which is a conveyance distance that may be corrected to eliminate the skew.

In order to correct Dskew using a speed area D1 and a speed area D2 in FIG. 9, the speed Vl and the speed Vu are obtained. In a case where Dskew=D1+D2 and the desired correction period T2−T1=20 msec, Vc×(TL−TR)/(T2−T1)=5 mm/20 msec=0.25 mm/msec=250 mm/s=D1+D2. When D1 and D2 are corrected equally, since the triangular area D1=20 msec×(Vc−Vl)/2, the speed Vl is 750 mm/s, and similarly, since the triangular area D2=20 msec×(Vu−Vc)/2, the speed Vu is 1250 mm/s. In this manner, the distance difference Dskew, the speed Vl, and the speed Vu used for the skew correction control according to the amount of skew can be obtained.

Note that, even if D1 and D2 are not corrected equally, the same skew correction effect can be obtained. For example, D1 and D2 may be distributed at a desired ratio rather than equally, and D1 and D2 may be implemented using trapezoidal speed driving rather than triangular speed driving. The method of calculating the speed Vl and the speed Vu for skew correction is an example, and the speeds may be determined by another method.

Meanwhile, since the left registration roller 31L and the right registration roller 31R are rotated independently by the left registration motor ML and the right registration motor MR, respectively, the rotational speeds of the rollers may not be exactly equal due to differences in motor characteristics. In addition, since the driving speeds of the left registration roller 31L and the right registration roller 31R are different during the skew correction control, the degrees of wear of the rollers are also different accordingly. Hereinafter, a method of correcting the rotational speeds of the left registration roller 31L and the right registration roller 31R to be equal so that the speeds of the rollers driven by different driving sources are equal will be described.

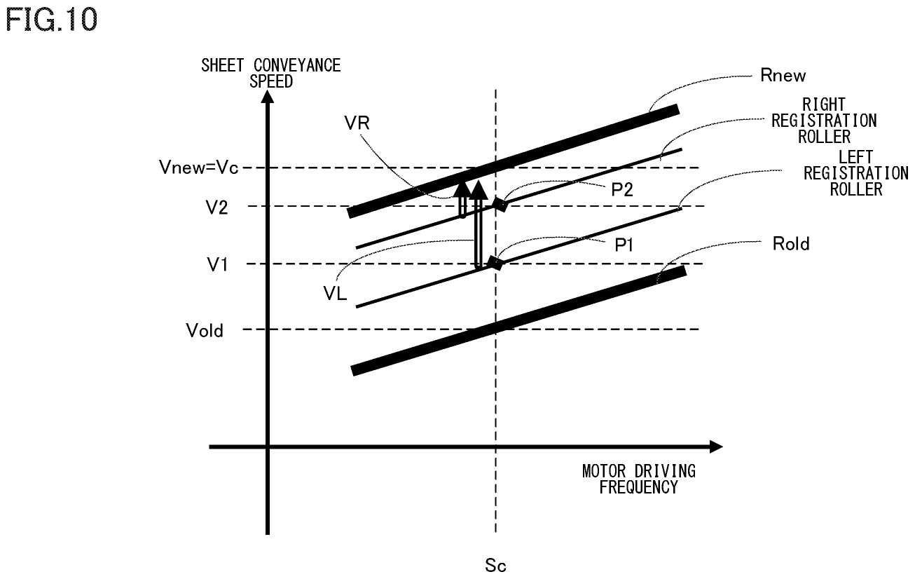

FIG. 10 is a graph schematically illustrating a relationship between motor driving speed and actual sheet conveyance speed that varies depending on the difference in diameter of the registration roller. The horizontal axis represents a driving frequency given to the registration motor, which is a stepping motor, and the vertical axis represents an actual sheet conveyance speed corresponding to the driving frequency. In general, a new registration roller Rnew has a larger diameter than a worn registration roller Rold because the surface of the new registration roller Rnew is not worn out by sheet conveyance. Therefore, as illustrated in FIG. 10, when the same motor driving frequency Sc is given to the registration motors, the sheet conveyance speed Vnew(=Vc) of the new registration roller Rnew is faster than the sheet conveyance speed Vold of the worn registration roller Rold.

This is because the registration rollers have the same rotation angle per stepping motor pulse, so the larger the diameter of the registration roller, the greater the amount of advancement per rotation, that is, the higher the outer peripheral speed of the roller, and accordingly, the higher the sheet conveyance speed as the actual conveyance speed. In addition, since the registration roller is worn and reduced in diameter as the apparatus is used and deteriorates over time, its conveyance speed decreases. The plurality of rollers may have different diameters due to factors other than wear, such as dimensional tolerances that occur when the rollers are manufactured.

Here, it is assumed that Sc corresponding to the above-described straight conveyance speed Vc used for straight conveyance is set to be output as a driving output to be given to the registration motor, for example, an input pulse frequency serving as a driving frequency in the stepping motor. In this case, due to factors such as degrees of wear of the registration rollers, the left registration roller 31L and the right registration roller 31R may actually have different conveyance speeds, a straight conveyance speed V1 (P1 in FIG. 10) and a straight conveyance speed V2 (P2 in FIG. 10), which may cause a difference in conveyance speed.

The present embodiment is to bring the actual sheet conveyance speeds, such as the straight conveyance speed V1 and the straight conveyance speed V2, closer to the ideal straight conveyance speed Vc by adding speeds, as indicated by VR and VL in FIG. 10, for correction. Although FIG. 10 illustrates an example in which the actual sheet conveyance speeds are slower than the ideal straight conveyance speed Vc, in a case where the actual sheet conveyance speeds are faster than the ideal straight conveyance speed Vc, this can be addressed by performing subtraction correction.

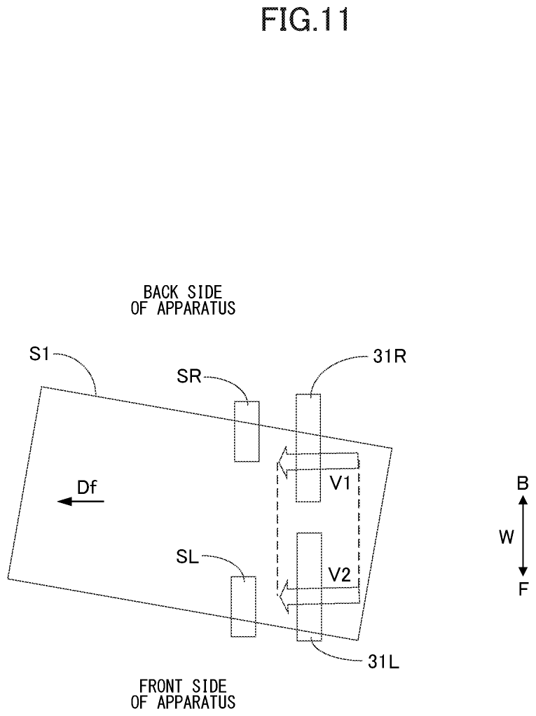

FIG. 11 is a top view schematically illustrating a state in which the skew of the sheet S1 after the skew correction processing is not eliminated due to a difference in sheet conveyance speed between the registration rollers. In a case where VR and VL for correction are not added, the skew is not sufficiently corrected even if the above-described skew correction processing is performed. Further, even though the speeds of the registration rollers become equal, the left registration roller 31L and the right registration roller 31R have different sheet conveyance speeds, like V1 and V2. As a result, due to the difference in amount of sheet advancement per unit time between the left registration roller 31L and the right registration roller 31R, the sheet may be conveyed while being skewed, like the sheet S1.

Speed Difference Adjustment Operation of Skew Correction Unit

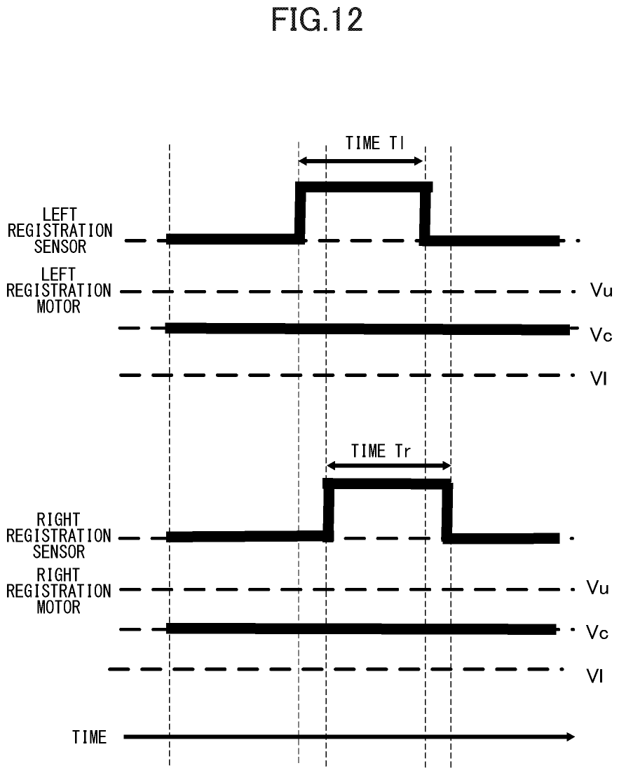

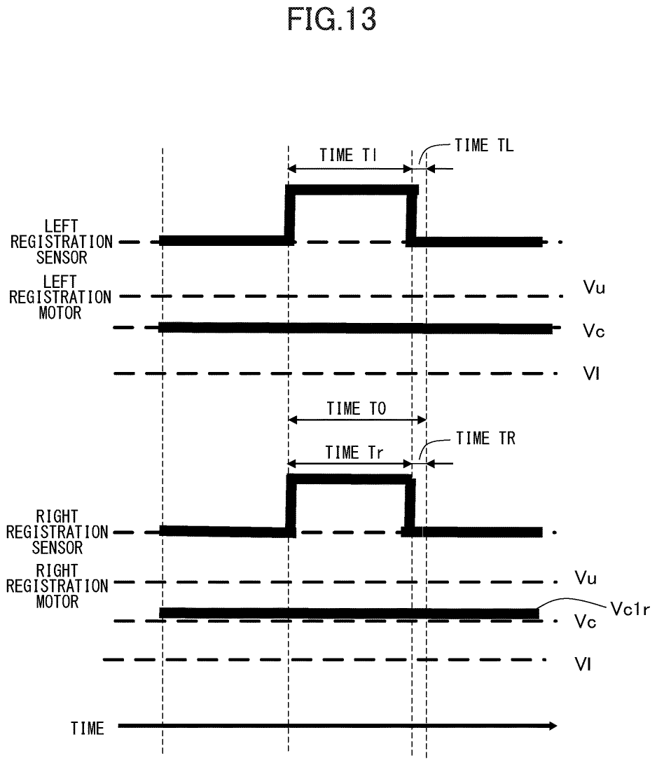

FIGS. 12 and 13 are timing charts schematically illustrating behaviors of registration sensors and registration motors during a “speed difference adjustment operation of the skew correction unit 30” for bringing the actual conveyance speeds close to the target speed according to the present embodiment. In the speed difference adjustment operation of the skew correction unit 30, first-stage correction is performed so that the difference in conveyance speed between the left registration roller 31L and the right registration roller 31R is reduced, and second-stage correction is performed so that the two registration rollers have an ideal sheet conveyance speed. In the first stage, a first test sheet is used, and in the second stage, a second test sheet is used. The test sheet may allow its leading edge and trailing edge in the sheet conveyance direction Df to be read, and an image formed on the sheet is unnecessary. Note that the above-described skew correction control is not executed in order to prevent the adjustment operation from being affected by the skew correction control on the test sheet for adjustment conveyed in the skew correction unit 30, which is a target to be adjusted by the speed difference adjustment operation of the skew correction unit 30.

FIG. 12 is a timing chart illustrating a sensor signal logic by which the registration sensors detect a sheet from its leading edge to its trailing edge and a target speed of the registration motors in the speed difference adjustment operation of the skew correction unit 30 in the first stage. In the speed difference adjustment operation of the skew correction unit 30, the first test sheet is conveyed at the straight conveyance speed Vc, and Tl and Tr, which are differences between times when the left registration sensor SL and the right registration sensor SR detect the leading edge and the trailing edge of the sheet, are acquired. Then, in order to match the speed of the right registration roller 31R with the speed of the left registration roller 31L, the speed ratio Tr/Tl, which is Tl to Tr, is calculated and multiplied by the driving frequency to obtain a new straight conveyance speed Vc1r at the driving frequency to be given to the right registration motor MR. For example, when Tr is 209.5 msec and Tl is 210 msec, Tr/Tl=0.9976, and when the straight conveyance speed Vc is 1000 mm/s, the new straight conveyance speed Vc1r at the driving frequency is 997.6 mm/s.

FIG. 13 is a timing chart illustrating a sensor signal logic by which the registration sensors detect a second test sheet from its leading edge to its trailing edge and a target speed of the motors in the second stage. In order to bring actual conveyance speeds close to the target speed, the test sheet is conveyed again in the conveyance control mode in which skew correction control is not performed as illustrated in FIG. 13. Again, times Tl and Tr at which the left registration sensor SL and the right registration sensor SR detect the leading edge and the trailing edge of the sheet are acquired. Then, a time ratio of Tl to an ideal conveyance time T0, which can be calculated by multiplying the target straight conveyance speed Vc by the length information of the sheet, is calculated and multiplied by Vc, and Vc is subtracted therefrom to obtain the differential speed VL.

For example, when T0 is 210 msec and Tl is 210.5 msec, 210.5/210=1.0023, and when the straight conveyance speed Vc=1000 mm/s, VL is 1002.3 mm/s−1000 mm/s=2.3 mm/s. Similarly, a ratio of Tr to T0 is calculated and multiplied by Vc, and Vc is subtracted therefrom to obtain the differential speed VR. Based on the obtained results, the actual conveyance speeds can be corrected to the target straight conveyance speeds Vc, Vu, and Vl by adding the differential speeds VL and VR to the driving frequencies given to the left registration motor ML and the right registration motor MR during the skew correction control.

In this manner, in the present embodiment, the driving frequencies applied to the registration motors are adjusted to be brought close to the target straight conveyance speeds Vc, Vu, and Vl used for skew correction control. As a result, it is possible to reduce a difference in sheet conveyance speed due to factors such as different registration motors as driving sources and degrees of wear of registration rollers, bringing the actual conveyance speeds close to the target speed. Therefore, even in a configuration in which the driving sources of the registration rollers are different, it is possible to improve the accuracy of the skew correction and the position of sheet when stacked by adjusting the difference in sheet conveyance speed.

As illustrated in FIG. 12, in the timing chart in the speed difference adjustment operation of the skew correction unit 30 in the first stage, the timing at which the left registration sensor SL detects the leading edge of the sheet is different from the timing at which the right registration sensor SR detects the leading edge of the sheet. On the other hand, as illustrated in FIG. 13, in the timing chart in the speed difference adjustment operation of the skew correction unit 30 in the second stage, the timing at which the left registration sensor SL detects the leading edge of the sheet is equal to the timing at which the right registration sensor SR detects the leading edge of the sheet.

This is because, in the speed difference adjustment operation of the skew correction unit 30 in the first stage, there is a difference between the conveyance speed of the left registration roller 31L and the conveyance speed of the right registration roller 31R. Therefore, there is a deviation between the timings at which the leading edge of the sheet reaches the sensors after the sheet is skewed in sections from the right registration roller 31R and the left registration roller 31L to the sensors SR and SL.

On the other hand, in the speed difference adjustment operation of the skew correction unit 30 in the second stage, since the difference between the conveyance speed of the left registration roller 31L and the conveyance speed of the right registration roller 31R is improved, the skew of the sheet in the sections from the right registration roller 31R and the left registration roller 31L to the sensors SR and SL is eliminated, and the timings at which the leading edge of the sheet reaches the respective sensors SR and SL are equal.

In the present embodiment, as a protective measure against a sudden abnormal situation such as an erroneous reaction of the sensor due to noise or the like, for example, an adjustment limit is set in the range of ±10 mm/s for the differential speed VL and the differential speed VR. Furthermore, when the adjustment limit is taken into consideration, it is not limited to give the adjusted speed as Vc1r only to the right registration motor MR side in the first stage. That is, the speed may be adjusted to Vc1l on the left registration motor ML side, and the speed adjustment may be performed so as to compensate for the speed difference by 50% of each of Vc1r and Vc1l. As a result, even in a speed difference relationship limited by the adjustment limit only using Vc1r on the right registration motor MR side, the speed can be adjusted to Vc1l separately on the left registration motor ML side, thereby substantially expanding the adjustment range. Furthermore, for example, in a case where the speed increase is set to Vc1l on the left registration motor ML side, the differential speed VL approaches the upper limit of +10 mm/s, and thus, there is a possibility that the adjustment range becomes insufficient when the differential speed VL is obtained by the second test sheet. Therefore, instead of adjusting the speed by 50% of each of Vc1r and Vc1l, the speed may be adjusted at a distribution ratio between Vc1r and Vc1l such that the median value of Vc1r and Vc1l becomes close to the straight conveyance speed Vc.

### Second Discharging Apparatus

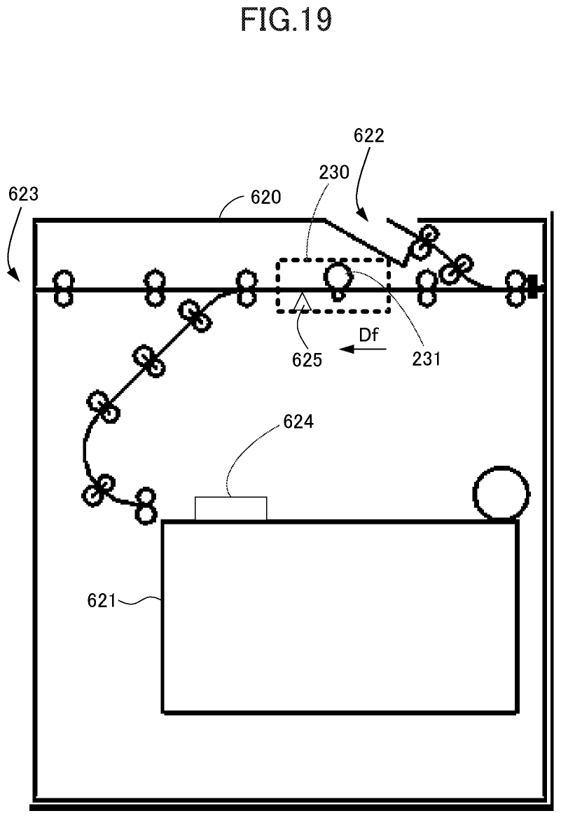

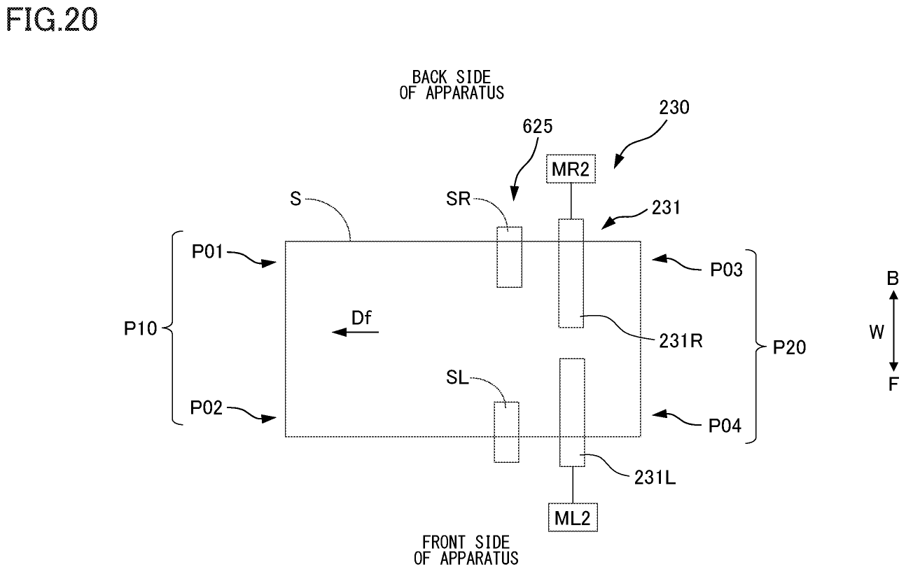

Although the first discharging apparatus 610 has been described above, the same applies to the second discharging apparatus 620. As illustrated in FIGS. 19 and 20, the second discharging apparatus 620 includes a right registration roller 231R, which is an example of a third conveyance roller or a third conveyance unit that conveys the sheet S, and a right registration motor MR2, which is an example of a third driving unit that drives the right registration roller 231R. The second discharging apparatus 620 includes a left registration roller 231L, which is an example of a fourth conveyance roller or a fourth conveyance unit disposed at a position different from that of the right registration roller 231R in the width direction W, the left registration roller 231L conveying a sheet together with the right registration roller 231R. The second discharging apparatus 620 includes a left registration motor ML2, which is an example of a fourth driving unit that drives the left registration roller 231L, and a registration sensor unit 625, which is an example of a second detection unit that detects the first detection target portion P10 and the second detection target portion P20 of the sheet. The discharging stacker 621 includes a side regulating unit 624.

### Speed Difference Adjustment Operation of Skew Correction Unit When Plurality of Discharging Apparatuses Are Connected

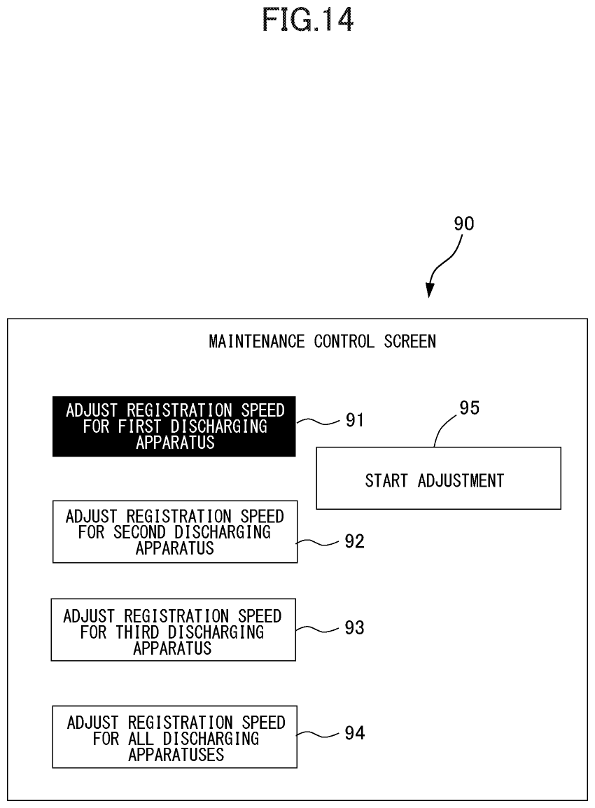

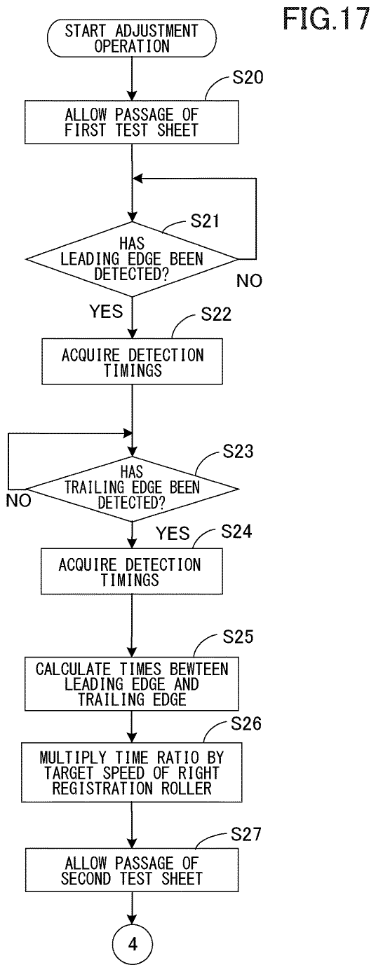

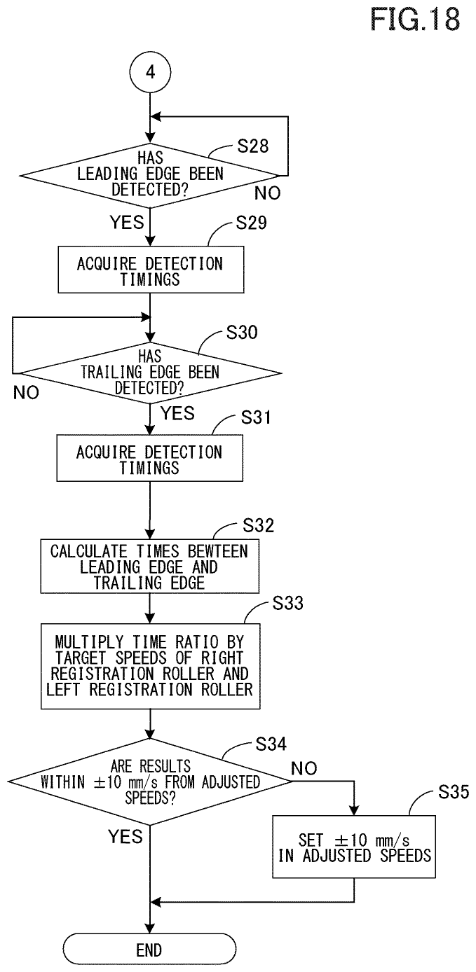

Next, a speed difference adjustment operation of the skew correction unit 30 when the plurality of discharging apparatuses are connected will be described with reference to FIGS. 14, 15, and 16. Here, a case where three discharging apparatuses, the first discharging apparatus 610, the second discharging apparatus 620, and the three third discharging apparatus 630, are connected as a plurality of discharging apparatuses will be described. The details of the processing for the speed difference adjustment operation of the skew correction unit 30 will be described with reference to FIGS. 17 and 18.

FIG. 14 is an example of a display screen 90 that receives adjustment operation instructions from a user through the operation unit I/F 78 and the display unit I/F 80 of the print server 70. The display screen 90 displays a first screen button 91, a second screen button 92, a third screen button 93, a fourth screen button 94, and an adjustment start button 95. The first screen button 91 is a button for selecting the speed difference adjustment operation of the skew correction unit 30 for the first discharging apparatus 610. The second screen button 92 is a button for selecting the speed difference adjustment operation of the skew correction unit for the second discharging apparatus 620. The third screen button 93 is a button for selecting the speed difference adjustment operation of the skew correction unit for the third discharging apparatus 630. The fourth screen button 94 is a button for collectively selecting the speed difference adjustment operation of the skew correction unit for the first discharging apparatus 610, the second discharging apparatus 620, and the third discharging apparatus 630.

The first screen button 91 is a screen button with a black background as an example of a state in which it is selected by the user, while each of the second screen button 92, the third screen button 93, and the fourth screen button 94 is a screen button with a white background as an example of an unselected state. Only one of the first screen button 91, the second screen button 92, the third screen button 93, and the fourth screen button 94 can be in a selected state. When another screen button is pressed, the most recently pressed screen button is in a selected state. By pressing the adjustment start button 95 after selecting one of the first screen button 91, the second screen button 92, the third screen button 93, and the fourth screen button 94, the speed adjustment operation process of the skew correction unit is executed. The speed adjustment operation process of the skew correction unit will be described below.

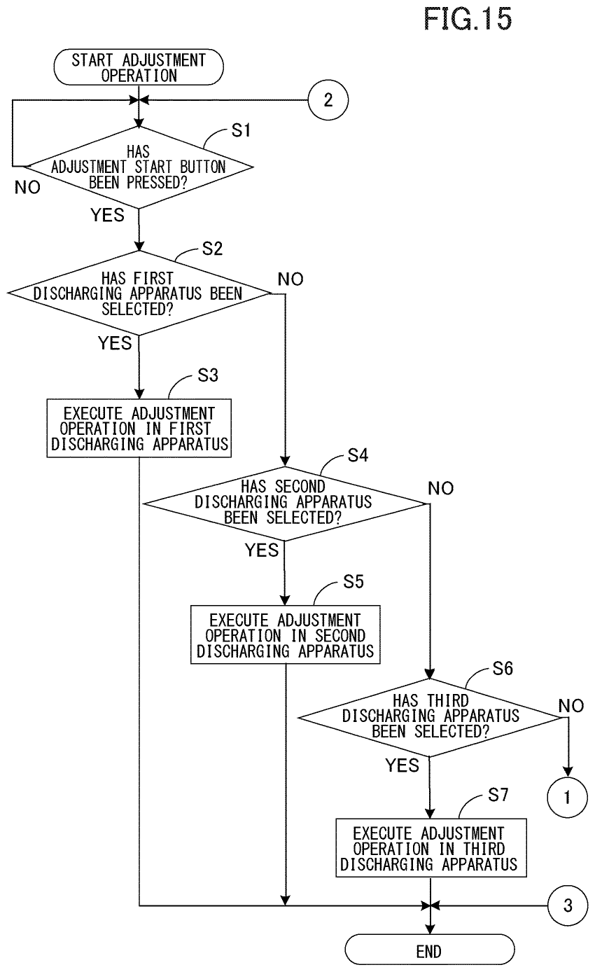

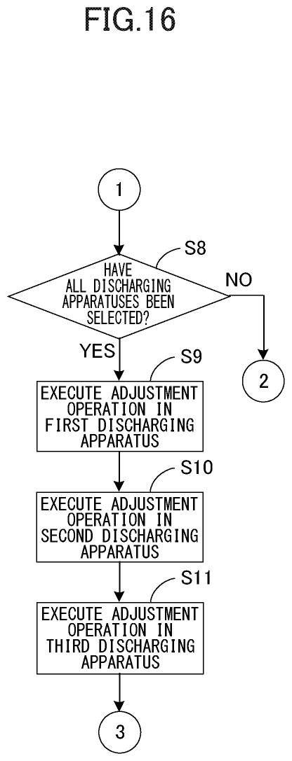

Next, a procedure of processing for the speed difference adjustment operation of the skew correction unit when a plurality of stacking apparatuses are connected will be described with reference to flowcharts illustrated in FIGS. 15 and 16. The process illustrated in the flowcharts of FIGS. 15 and 16 is executed by the CPU 71. The CPU 71 determines whether the adjustment start button 95 illustrated in FIG. 14 has been pressed (S1). When it is determined that the adjustment start button 95 has not been pressed (S1; NO), the CPU 71 determines again whether the adjustment start button 95 has been pressed.

When it is determined that the adjustment start button 95 has been pressed (S1; YES), the CPU 71 determines whether the screen button 91 for designating the first discharging apparatus 610 as an adjustment target is in a selected state (S2). When it is determined that the screen button 91 is in the selected state (S2; YES), the CPU 71 executes processing for the speed difference adjustment operation of the skew correction unit 30 in the first discharging apparatus 610 (S3), and ends the process. Here, when it is detected that a sheet is skewed in the second discharging apparatus 620 or the third discharging apparatus 630 while the processing for the speed difference adjustment operation is executed in the first discharging apparatus 610, the skew of the sheet is corrected in the second discharging apparatus 620 or the third discharging apparatus 630.

When it is determined that the screen button 91 is not in the selected state (S2; NO), the CPU 71 determines whether the screen button 92 for designating the second discharging apparatus 620 as an adjustment target is in a selected state (S4). When it is determined that the screen button 92 is in the selected state (S4; YES), the CPU 71 executes processing for the speed difference adjustment operation of the skew correction unit in the second discharging apparatus 620 (S5), and ends the process. Here, when it is detected that a sheet is skewed in the first discharging apparatus 610 or the third discharging apparatus 630 while the processing for the speed difference adjustment operation is executed in the second discharging apparatus 620, the skew of the sheet is corrected in the first discharging apparatus 610 or the third discharging apparatus 630.

As will be described below, the first discharging apparatus 610 can execute first processing as a part of the processing for the speed difference adjustment operation, and the second discharging apparatus 620 can execute third processing as a part of the processing for the speed difference adjustment operation. Therefore, the CPU 71 selects and executes at least one of the first processing and the third processing.

When it is determined that the screen button 92 is not in the selected state (S4; NO), the CPU 71 determines whether the screen button 93 for designating the third discharging apparatus 630 as an adjustment target is in a selected state (S6). When it is determined that the screen button 93 is in the selected state (S6; YES), the CPU 71 executes processing for the speed difference adjustment operation of the skew correction unit in the third discharging apparatus 630 (S7), and ends the process. Here, when it is detected that a sheet is skewed in the first discharging apparatus 610 or the second discharging apparatus 620 while the processing for the speed difference adjustment operation is executed in the third discharging apparatus 630, the skew of the sheet is corrected in the first discharging apparatus 610 or the second discharging apparatus 620.

When it is determined that the screen button 93 is not in the selected state (S6; NO), the CPU 71 determines whether the screen button 94 for designating all the discharging apparatuses as adjustment targets is in a selected state (S8). When it is determined that the screen button 94 is not in the selected state (S8; NO), the CPU 71 determines that the adjustment start button 95 has been pressed, for example, due to an erroneous operation or the like, and returns to the adjustment start determination step (S1).

When it is determined that the screen button 94 is in the selected state (S8; YES), the CPU 71 first executes processing for the speed difference adjustment operation of the skew correction unit 30 in the first discharging apparatus 610 (S9). Next, the CPU 71 executes processing for the speed difference adjustment operation of the skew correction unit in the second discharging apparatus 620 (S10), and further executes processing for the speed difference adjustment operation of the skew correction unit in the third discharging apparatus 630 (S11). That is, in a case where both the first processing (S9) and the third processing (S10) are executed, the CPU 71 executes the third processing in a state where the execution of the first processing is completed. In this way, when it is desired to collectively adjust the plurality of discharging apparatuses, it is preferable to perform the adjustment operation from the discharging apparatus on the upstream side in the sheet conveyance direction. By doing so, the sheet can be conveyed to the discharging apparatus on the downstream side with a more accurate skew correction result than by not doing so.

Processing for Speed Difference Adjustment Operation of Skew Correction Unit

Next, a procedure of processing for the speed difference adjustment operation of the skew correction unit 30 will be described with reference to flowcharts illustrated in FIGS. 17 and 18. The processing illustrated in the flowcharts of FIGS. 17 and 18 is executed by the conveyance control unit 21 (see FIG. 2). Here, the description will be made using the first discharging apparatus 610, but the same processing procedure also applies to the second discharging apparatus 620 and the third discharging apparatus 630.

In the present embodiment, the processing is executed by the user when there is a concern about an occurrence of a speed difference, for example, for the reason that the skew correction unit 30 is replaced by the user or skew occurs due to the influence of wear of the left registration roller 31L and the right registration roller 31R. That is, as described in the flowcharts of FIGS. 15 and 16, when the user performs an adjustment execution operation, the processing for the speed difference adjustment operation of the skew correction unit 30 is started and executed by the conveyance control unit 21. Note that, although the processing for the speed difference adjustment operation of the skew correction unit 30 is executed when the user performs an execution operation, but the processing is not limited thereto. For example, the processing may be automatically performed at a time point when the number of sheets having passed through the skew correction unit 30 exceeds a predetermined number, such as 10,000 sheets, at a time point when a predetermined period has elapsed since the last replacement of the skew correction unit 30, or the like.

During the execution of the flowcharts of FIGS. 17 and 18, the conveyance control unit 21 disables the skew correction function of the skew correction unit 30 of the target first discharging apparatus 610 so that the skew correction unit 30 does not perform skew correction. The conveyance control unit 21 conveys the first test sheet so as to pass through the skew correction unit 30 of the first discharging apparatus 610 (S20). The test sheet is used for adjustment, and there is no need to print or fix an image on the test sheet.

The conveyance control unit 21 determines whether both the left registration sensor SL and the right registration sensor SR have detected the leading edge of the test sheet (S21). When it is determined that at least one of the left registration sensor SL and the right registration sensor SR does not detect the leading edge of the test sheet (step S21; NO), the conveyance control unit 21 makes a determination again (S21). When it is determined that both the left registration sensor SL and the right registration sensor SR have detected the leading edge of the test sheet (S21; YES), the conveyance control unit 21 acquires times when the left registration sensor SL and the right registration sensor SR detected the leading edge from the RAM 12 (S22).

The conveyance control unit 21 determines whether both the left registration sensor SL and the right registration sensor SR have detected the trailing edge of the test sheet (S23). When it is determined that at least one of the left registration sensor SL and the right registration sensor SR has not detected the trailing edge of the test sheet (step S23; NO), the conveyance control unit 21 makes a determination again (S23). When it is determined that both the left registration sensor SL and the right registration sensor SR have detected the trailing edge of the test sheet (step S23; YES), the conveyance control unit 21 acquires times when the left registration sensor SL and the right registration sensor SR detected the trailing edge from the RAM 12 (S24).

The conveyance control unit 21 calculates times during which the sheet has been detected based on the times when the left registration sensor SL and the right registration sensor SR detected the leading edge and the times when the left registration sensor SL and the right registration sensor SR detected the trailing edge (S25). The conveyance control unit 21 multiplies the calculated time ratio R/L by the target speed of the right registration roller 31R driven by the right registration motor MR, and sets the result as a new straight conveyance speed Vc1r (S26).

That is, the conveyance control unit 21 executes first processing based on a first detection result of detecting the first detection target portion P10 and a second detection result of detecting the second detection target portion P20. As the first processing, the conveyance control unit 21 controls at least one of the right registration motor MR and the left registration motor ML so as to reduce a difference between a first conveyance speed of the sheet through the right registration roller 31R and a second conveyance speed of the sheet through the left registration roller 31L. In the present embodiment, the conveyance control unit 21 executes the first processing based on a difference in detection timing between the first detection target position P01 and the third detection target position P03 and a difference in detection timing between the second detection target position P02 and the fourth detection target position P04.

In the second discharging apparatus 620, the conveyance control unit 21 executes third processing based on a first detection result of detecting the first detection target portion P10 and a second detection result of detecting the second detection target portion P20. As the third processing, the conveyance control unit 21 controls at least one of the right registration motor MR2 and the left registration motor ML2 so as to reduce a difference between a first conveyance speed of the sheet through the right registration roller 231R and a second conveyance speed of the sheet through the left registration roller 231L. In the present embodiment, the conveyance control unit 21 executes the third processing based on a difference in detection timing between the first detection target position P01 and the third detection target position P03 and a difference in detection timing between the second detection target position P02 and the fourth detection target position P04.

Next, the conveyance control unit 21 conveys a second test sheet so as to pass through the skew correction unit 30 of the first discharging apparatus 610 (S27). The conveyance control unit 21 determines whether both the left registration sensor SL and the right registration sensor SR have detected the leading edge of the test sheet (S28). When it is determined that at least one of the left registration sensor SL and the right registration sensor SR does not detect the leading edge of the test sheet (step S28; NO), the conveyance control unit 21 makes a determination again (S28). When it is determined that both the left registration sensor SL and the right registration sensor SR have detected the leading edge of the test sheet (S28; YES), the conveyance control unit 21 acquires times when the left registration sensor SL and the right registration sensor SR detected the leading edge from the RAM 12 (S29).

The conveyance control unit 21 determines whether both the left registration sensor SL and the right registration sensor SR have detected the trailing edge of the test sheet (S30). When it is determined that at least one of the left registration sensor SL and the right registration sensor SR has not detected the trailing edge of the test sheet (step S30; NO), the conveyance control unit 21 makes a determination again (S30). When it is determined that both the left registration sensor SL and the right registration sensor SR have detected the trailing edge of the test sheet (step S30; YES), the conveyance control unit 21 acquires times when the left registration sensor SL and the right registration sensor SR detected the trailing edge from the RAM 12 (S31).

The conveyance control unit 21 calculates times during which the sheet has been detected based on the times when the left registration sensor SL and the right registration sensor SR detected the leading edge and the times when the left registration sensor SL and the right registration sensor SR detected the trailing edge (S32). The conveyance control unit 21 obtains a ratio between ideal conveyance times based on the calculated times and the target straight conveyance speed Vc, multiplies the ratio by the target straight conveyance speed Vc, and calculates differences from Vc, thereby obtaining a differential speed VR and a differential speed VL (S33).

The conveyance control unit 21 determines whether the differential speed VR and the differential speed VL fall within the adjustment limit, for example, ±10 mm/s, from Vc (S34). When it is determined that the differential speed VR and the differential speed VL fall within ±10 mm/s from Vc (S34; YES), the conveyance control unit 21 applies the differential speed VR and the differential speed VL as they are, and ends the processing.

When it is determined that at least one of the differential speed VR and the differential speed VL does not fall within ±10 mm/s from Vc (S34; NO), the conveyance control unit 21 applies ±10 mm/s to any of the differential speed VR and the differential speed VL that exceeds the limit (S35). Specifically, the conveyance control unit 21 applies +10 mm/s to any of the differential speed VR and the differential speed VL that exceeds +10 mm/s, and applies −10 mm/s to any of the differential speed VR and the differential speed VL that falls below −10 mm/s.

That is, the conveyance control unit 21 executes second processing on a second sheet subsequent to the first sheet in a state where the first processing has been executed on the preceding first sheet. As the second processing, the conveyance control unit 21 controls at least one of the right registration motor MR and the left registration motor ML so as to reduce a difference between the first conveyance speed and Vc, which is a predetermined target speed, and reduce a difference between the second conveyance speed and Vc.

In the processing for the speed difference adjustment operation of the skew correction unit described above, as a first stage, the control unit 10 executes a first step based on the first detection result of detecting the first detection target portion P10 and the second detection result of detecting the second detection target portion P20. In the first step, at least one of the right registration motor MR and the left registration motor ML is controlled so as to reduce a difference between a first conveyance speed of the sheet through the right registration roller 31R and a second conveyance speed of the sheet through the left registration roller 31L (S20 to S26).

In addition, as a second stage, a second step is executed to control at least one of the right registration motor MR and the left registration motor ML so as to reduce a difference between a first conveyance speed and Vc, which is a predetermined target speed, and reduce a difference between the second conveyance speed and Vc (S27 to S33). Then, the second step is performed on the second sheet subsequent to the first sheet after the execution of the first step is completed on the first sheet.

In this manner, the obtained differential speed VL is added to the driving frequency given to the left registration motor ML, including the skew correction control, and the obtained differential speed VR is added to the driving frequency given to the right registration motor MR, including the skew correction control. As a result, even in a configuration in which the driving sources of the registration rollers are different, it is possible to improve the accuracy of the skew correction and the position of sheet when stacked by adjusting differences between ideal target speeds and actual conveyance speeds. The differential speed VR and the differential speed VL are stored in the RAM 12, and used for the skew correction control of the skew correction unit 30, for example, in the printing operation, after the processing for the speed difference adjustment operation of the skew correction unit 30 is ended. Furthermore, in order to substantially expand the adjustment range in consideration of the adjustment limit, in S26, not only Vc1r for the right registration motor MR but also Vc1l for the left registration motor ML may be set, or both may be set.

As described above, in the present embodiment, an adjustment execution operation is performed by the user when there is a concern about an occurrence of a speed difference, for example, for the reason that the skew correction unit 30 is replaced by the user or skew occurs due to the influence of wear of the left registration roller 31L and the right registration roller 31R. As a result, two test sheets are conveyed to the skew correction unit 30, and two-stage processing for the speed difference adjustment operation is performed. In the first stage, the driving frequency of the right registration motor MR is adjusted so that the actual sheet conveyance speeds of the left registration roller 31L and the right registration roller 31R become identical based on the times when the leading edge and the trailing edge of the first test sheet are detected. In the second stage, the driving frequencies of the right registration motor MR and the left registration motor ML are adjusted so that the actual sheet conveyance speeds of the left registration roller 31L and the right registration roller 31R become ideal target speeds based on the times when the leading edge and the trailing edge of the second test sheet are detected. By doing so, even in a configuration without expensive reading sensors that read a test pattern (image) printed on a test sheet, a speed difference can be adjusted only by inexpensive sheet presence/absence sensors, which improves the accuracy of the skew correction and the position of sheet when stacked.

As described above, the skew correction unit 30 according to the present embodiment executes the first processing to reduce the difference between the first conveyance speed of the sheet through the right registration roller 31R and the second conveyance speed of the sheet through the left registration roller 31L. Since the sheet conveyance speeds become equal between the right registration roller 31R and the left registration roller 31L, the accuracy of the skew correction can be improved. Therefore, it is possible to prevent the sheet from abutting against the side regulating unit 614 due to poor accuracy of skew correction. In addition, since the sheet sensors are used without using image reading sensors, an increase in cost can be suppressed.

In addition, the skew correction unit 30 according to the present embodiment executes the second processing to bring the speeds of the right registration roller 31R and the left registration roller 31L close to the target speed. Therefore, the accuracy of skew correction can be improved without reducing productivity. In addition, since the second processing is executed in a state where the first processing has been performed and the speeds of the right registration roller 31R and the left registration roller 31L become equal, the accuracy of speed adjustment can be further enhanced as compared with that in a case where the first processing is not performed.

In the embodiment described above, the speeds of the right registration roller 31R and the left registration roller 31L are adjusted in two stages, the first processing and the second processing, but the adjustment of the speeds of the right registration roller 31R and the left registration roller 31L is not limited thereto. For example, the first processing may be omitted, the second processing may be executed from the beginning, and the conveyance speeds of the right registration roller 31R and the left registration roller 31L may be controlled to be close to the target speed. In this case, the adjustment processing can be simplified and speeded up.

In the embodiment described above, the case where the first detection target portion P10 of the sheet is the leading edge and the second detection target portion P20 is the trailing edge has been described, but the first detection target portion P10 and the second detection target portion P20 are not limited thereto. For example, the first detection target portion P10 may be a leading edge side of the side edge of the sheet, and the second detection target portion P20 may be a trailing edge side of the side edge of the sheet. In this case, the side edge of the sheet can be detected by a CIS or the like, and a conveyance speed can be calculated from the difference between the positions of the first detection target portion P10 and the second detection target portion P20.

Furthermore, in the above-described embodiment, the case where the present disclosure is applied to the skew correction unit 30 of the discharging apparatus has been described, but the application of the present disclosure is not limited thereto, and the present disclosure may be applied to other skew correction units. For example, the fixing unit 300 also includes a skew correction unit 311 having the same configuration as the skew correction unit 30 described with reference to FIGS. 6 to 8 (see FIG. 1B). When duplex printing is performed, after the front surface is printed by the printing unit 200, the sheet is conveyed to a duplex conveyance path so that the back surface is printed from a duplex conveyance port 401 of the cooling unit 400. In this case, before the back surface is printed, the skew of the sheet is corrected by the skew correction control described with reference to FIG. 9 to align the position of the image to be printed at the location of the inkjet head 201 with the position of the sheet. Therefore, the processing for the speed difference adjustment operation of the skew correction unit described with reference to FIGS. 17 and 18 is applied to the skew correction unit 311, similarly to the skew correction unit 30. As a result, it is possible to adjust a speed difference between an ideal target speed and an actual conveyance speed to improve the accuracy of skew correction for aligning the image to be printed with the sheet when the image is printed on the back surface of the sheet.

In addition, the image forming system 1 described in the present embodiment is an example, and any system may be used as long as it has a configuration in which paper is conveyed and a conveyance path is switched by a switching unit. In particular, the image forming unit is not limited to the inkjet type, and may be, for example, an electrophotographic type.

The present disclosure can also be realized by processing in which a program for implementing one or more functions of the above-described embodiment is supplied to a system or an apparatus via a network or a storage medium, and one or more processors in a computer of the system or the apparatus read and execute the program. The present disclosure can also be realized by a circuit (e.g., ASIC) for implementing one or more functions.

According to the present disclosure, the accuracy of skew correction can be improved.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-042447, filed Mar. 17, 2025, which is hereby incorporated by reference herein in its entirety.

What is claimed is:

1. A sheet conveyance apparatus comprising:
a first conveyance roller configured to convey a sheet in a sheet conveyance direction;
a first driving unit configured to drive the first conveyance roller;
a second conveyance roller disposed at a position different from that of the first conveyance roller in a width direction intersecting the sheet conveyance direction;
a second driving unit configured to drive the second conveyance roller;
a first detection unit disposed on one side in the width direction, and configured to detect the sheet;
a second detection unit disposed on another side opposite to the one side in the width direction, and configured to detect the sheet; and
a control unit configured to control the first driving unit and the second driving unit,
wherein the control unit is configured to execute first processing to control at least one of the first driving unit and the second driving unit so as to reduce a difference between a first conveyance speed of the sheet through the first conveyance roller and a second conveyance speed of the sheet through the second conveyance roller based on a first detection result in which a leading edge of a predetermined sheet is detected by the first detection unit, a second detection result in which a trailing edge of the predetermined sheet is detected by the first detection unit, a third detection result in which the leading edge of the predetermined sheet is detected by the second detection unit, and a fourth detection result in which the trailing edge of the predetermined sheet is detected by the second detection unit.

2. The sheet conveyance apparatus according to claim 1, wherein
the control unit is configured to execute the first processing based on:
a time from a timing at which the leading edge of the predetermined sheet is detected by the first detection unit to a timing at which the trailing edge of the predetermined sheet is detected by the first detection unit; and
a time from a timing at which the leading edge of the predetermined sheet is detected by the second detection unit to a timing at which the trailing edge of the predetermined sheet is detected by the second detection unit.

3. The sheet conveyance apparatus according to claim 1, wherein
the first detection unit is disposed at a position overlapping the second detection unit as viewed in the width direction.

4. The sheet conveyance apparatus according to claim 1, wherein
the control unit is configured to execute second processing in a state where the first processing has been executed on a first sheet,
the second processing being executed on a second sheet subsequent to the first sheet to control at least one of the first driving unit and the second driving unit to reduce a difference between the first conveyance speed and a predetermined target speed and to reduce a difference between the second conveyance speed and the predetermined target speed.

5. The sheet conveyance apparatus according to claim 4, wherein
in the second processing, the control unit is configured to:
control the first driving unit based on a time from a timing at which a leading edge of the second sheet is detected by the first detection unit to a timing at which a trailing edge of the second sheet is detected by the first detection unit and a target time corresponding to the predetermined target speed; and
control the second driving unit based on a time from a timing at which the leading edge of the second sheet is detected by the second detection unit to a timing at which the trailing edge of the second sheet is detected by the second detection unit and the target time corresponding to the predetermined target speed.

6. The sheet conveyance apparatus according to claim 1, further comprising:
a stacking portion disposed downstream of the first conveyance roller and the second conveyance roller in the sheet conveyance direction, and configured to stack the sheet conveyed by the first conveyance roller and the second conveyance roller.

7. The sheet conveyance apparatus according to claim 6, further comprising:
a pair of side regulating parts configured to abut on ends in the width direction of the sheet stacked on the stacking portion to restrict a position of the sheet.

8. The sheet conveyance apparatus according to claim 1, wherein
the first conveyance roller is disposed at a position overlapping the second conveyance roller as viewed in the width direction.

9. The sheet conveyance apparatus according to claim 1, wherein
the control unit is configured to execute skew correction processing to control at least one of the first driving unit and the second driving unit to correct skew of the sheet by increasing the difference between the first conveyance speed of the sheet through the first conveyance roller and the second conveyance speed of the sheet through the second conveyance roller based on a timing at which the first detection unit detects the leading edge of the sheet and a timing at which the second detection unit detects the leading edge of the sheet, and
the control unit does not execute the skew correction processing while the first processing is being executed.

10. An image forming system comprising:
an image forming apparatus configured to form an image on a sheet; and
the sheet conveyance apparatus according to claim 1 configured to convey the sheet on which the image has been formed in the image forming apparatus.

11. The image forming system according to claim 10, wherein
while the control unit is executing the first processing, the image forming apparatus does not form an image on the predetermined sheet.

12. The image forming system according to claim 10, further comprises:
a second sheet conveyance apparatus, where the sheet conveyance apparatus is a first sheet conveyance apparatus,
wherein the second sheet conveyance apparatus is disposed downstream of the first sheet conveyance apparatus in the sheet conveyance direction,
wherein the second sheet conveyance apparatus includes:
a third conveyance roller configured to convey the sheet in the sheet conveyance direction;
a third driving unit configured to drive the third conveyance roller;
a fourth conveyance roller disposed at a position different from that of the third conveyance roller in the width direction;
a fourth driving unit configured to drive the fourth conveyance roller;
a third detection unit disposed on one side in the width direction, and configured to detect the sheet; and
a fourth detection unit disposed on another side opposite to the one side in the width direction, and configured to detect the sheet, and
wherein the control unit is configured to execute third processing to control at least one of the third driving unit and the fourth driving unit so as to reduce a difference between a third conveyance speed of the sheet through the third conveyance roller and a fourth conveyance speed of the sheet through the fourth conveyance roller based on a fifth detection result in which a leading edge of a third sheet is detected by the third detection unit, a sixth detection result in which a trailing edge of the third sheet is detected by the third detection unit, a seventh detection result in which the leading edge of the third sheet is detected by the fourth detection unit, and an eighth detection result in which the trailing edge of the third sheet is detected by the fourth detection unit.

13. The image forming system according to claim 12, further comprising:
an operation unit operated by a user,
wherein the operation unit includes a first button for executing the first processing in the first sheet conveyance apparatus and a second button for executing the third processing in the second sheet conveyance apparatus.

14. The image forming system according to claim 12, wherein
the control unit is configured to execute the third processing in a state where execution of the first processing is completed, in a case where both the first processing and the third processing are executed.

15. The image forming system according to claim 12, wherein
the control unit is configured to control at least one of the third driving unit and the fourth driving unit to correct skew of the sheet, in a case where the skew of the sheet is detected in the second sheet conveyance apparatus based on the detection results of the third detection unit and the fourth detection unit, while the first processing is being executed in the first sheet conveyance apparatus.

16. The image forming system according to claim 12, wherein
the control unit is configured to control at least one of the first driving unit and the second driving unit to correct skew of the sheet, in a case where the skew of the sheet is detected in the first sheet conveyance apparatus based on a detection result of the first detection unit, while the third processing is being executed in the second sheet conveyance apparatus.

17. A method of controlling a sheet conveyance apparatus including:
a first conveyance roller configured to convey a sheet in a sheet conveyance direction;
a first driving unit configured to drive the first conveyance roller;
a second conveyance roller disposed at a position different from that of the first conveyance roller in a width direction intersecting the sheet conveyance direction;
a second driving unit configured to drive the second conveyance roller;
a first detection unit disposed on one side in the width direction, and configured to detect the sheet;
a second detection unit disposed on another side opposite to the one side in the width direction, and configured to detect the sheet; and
a control unit configured to control the first driving unit and the second driving unit, the method comprising:
a first step, executed by the control unit, of controlling at least one of the first driving unit and the second driving unit so as to reduce a difference between a first conveyance speed of the sheet through the first conveyance roller and a second conveyance speed of the sheet through the second conveyance roller based on a first detection result in which a leading edge of a predetermined sheet is detected by the first detection unit, a second detection result in which a trailing edge of the predetermined sheet is detected by the first detection unit, a third detection result in which the leading edge of the predetermined sheet is detected by the second detection unit, and a fourth detection result in which the trailing edge of the predetermined sheet is detected by the second detection unit.

18. The method of controlling the sheet conveyance apparatus according to claim 17, further comprising:
a second step, executed by the control unit, of controlling at least one of the first driving unit and the second driving unit so as to reduce a difference between the first conveyance speed and a predetermined target speed and to reduce a difference between the second conveyance speed and the predetermined target speed,
wherein, after execution of the first step is completed on a first sheet, the second step is executed on a second sheet subsequent to the first sheet.
